(19) United States
(12) Patent Application Publication
(10) Pub. No.: US 2012/0170866 A1
(43) Pub. Date: Jul. 5, 2012

(54) ELECTRONIC DEVICE AND IMAGE COMPARISON METHOD THEREOF

(75) Inventors: YU-KAI XIONG, Shenzhen (CN); XIN LU, Shenzhen (CN); SHIH-FANG WONG, Tu-Cheng (TW); FEI WANG, Shenzhen (CN); XIN-HUA LI, Shenzhen (CN); DONG-SHENG LV, Shenzhen (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/046,784

(22) Filed: Mar. 14, 2011

(30) Foreign Application Priority Data
Dec. 30, 2010 (CN) 201010614861.0

(51) Int. Cl. G06K 9/36

(52) U.S. Cl. 382/276

(57) ABSTRACT

The disclosure relates to an electronic device with image comparison function and an image comparison method utilized in the electronic device. The method includes loading a multimedia file in response to a first input signal and processing the multimedia file to form a two-dimensional array of each image and generate pixels of each image, acquiring a selection reference value in response to a second input signal and selecting an image comparison algorithm according to the acquired selection reference value, and comparing with the pixels of two adjacent images according to the selected image comparison algorithm and obtaining a comparison result.

### BACKGROUND

1. Technical Field

The disclosure relates to image capture technology and, more particularly, to an electronic device with image comparison and an image comparison method utilized by the electronic device.

2. Description of Related Art

In a popular method of image comparison, one comparison algorithm is generally employed in the course of image processing. However, when comparing two images quickly, precision of the result is compromised based on the single comparison algorithm. To obtain accuracy in the comparison result, speed thereof has often to be sacrificed.

Therefore, what is needed is an electronic device with image comparison and method to overcome the limitations described.

### BRIEF DESCRIPTION OF THE DRAWINGS

FIG. 1 is a block diagram of an electronic device with image comparison function in accordance with an exemplary embodiment.

FIG. 2 is a block diagram of a control unit of the electronic device of FIG. 1.

FIG. 3 is a flowchart of an image comparison method utilized in an electronic device such as, for example, that of FIG. 1.

### DETAILED DESCRIPTION

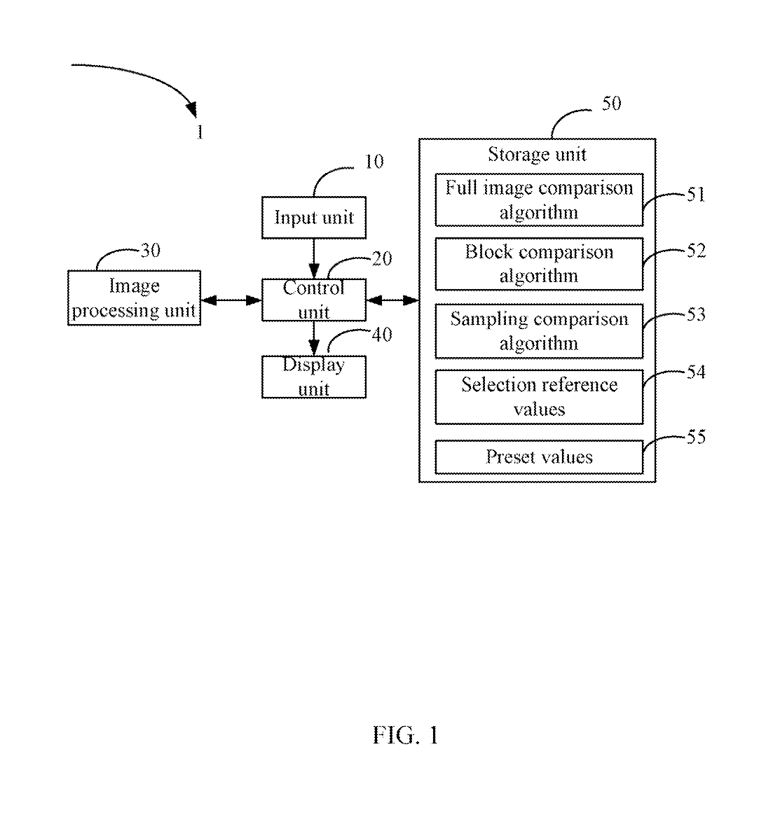

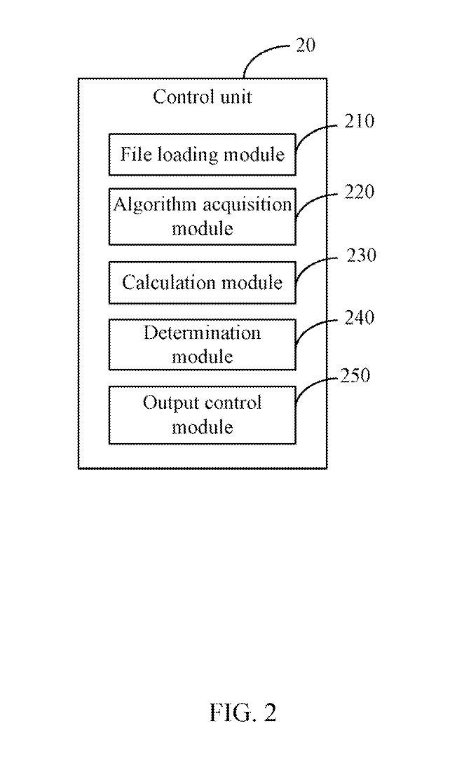

FIG. 1 is a block diagram of an electronic device with image comparison function in accordance with an exemplary embodiment. The electronic device with image comparison function (hereinafter “the electronic device”) 1 includes an input unit 10, a control unit 20, an image processing unit 30, a display unit 40, and a storage unit 50. The input unit 10 is configured for generating input signals in response to user input. The control unit 20 is configured for controlling the electronic device 1. As shown in FIG. 2, the control unit 20 further includes a file loading module 210, an algorithm acquisition module 220, a calculation module 230, and an output control module 250. The image processing unit 30 is configured for processing images from the electronic device 1 to form a two-dimensional array of each image and generate pixels of each image. The display unit 40 is configured for displaying information.

The storage unit 50 is configured for storing a plurality of image comparison algorithms and a plurality of selection reference values 54, each of which corresponds to one algorithm. In the embodiment, three image comparison algorithms are utilized. For example, the image comparison algorithms can include a full image comparison algorithm 51, a block comparison algorithm 52, and a sampling comparison algorithm 53.

The full image comparison algorithm 51 is configured for comparing each pixel of the two-dimensional array of one image with that of an adjacent image (for example, an image following the first image) and obtaining a similarity value. For example, if both adjacent images include 100 pixels, and eighty similar pixels are identified between the two adjacent images, the similarity value of the full image comparison algorithm 51 is 80%.

The block comparison algorithm 52 is configured for dividing each image into a predetermined number of blocks, comparing each pixel of the two-dimensional array for each block of one image with those of an adjacent image, and obtaining a similarity value. For example, if both adjacent images are divided into 100 blocks, and a predetermined number of pixels of a block of one image are similar to those of the corresponding block of an adjacent image, the two comparison blocks are deemed similar, such that, when sixty similar blocks are identified between the two adjacent images, the similarity value of the block comparison algorithm 52 is 60%.

The sampling comparison algorithm 53 is configured for sampling a predetermined length of continuous pixels of the two-dimensional array of one image at random, comparing each pixel of the predetermined length of pixels of the image with that of an adjacent image, and obtaining a similarity value. For example, fifty pixels in both the two adjacent images are sampled, when there are 35 similar pixels in the sampled fifty pixels, the similarity value of the sampling comparison algorithm 53 is 70%.

As described above, it is apparent that an accuracy of the comparison result of the full image comparison algorithm 51 would be higher than that of the block comparison algorithm 52 or the sampling comparison algorithm 53, but a comparison speed of the full image comparison algorithm 51 would be slower than that of the block comparison algorithm 52 or the sampling comparison algorithm 53.

The file loading module 210 is configured for loading a multimedia file in response to a first input signal from the input unit 10 and controlling the image processing unit 30 to process the multimedia file to generate pixels of the two-dimensional array of each image of the multimedia file. For example, the multimedia file is a video file and the video file is composed of a plurality of images. The algorithm acquisition module 220 is configured for acquiring a selection reference value in the selection reference values 54 in response to a second input signal from the input unit 10 and selecting an image comparison algorithm according to the selected reference value. The calculation module 230 is configured for comparing with the pixels of the two-dimensional arrays of two adjacent images according to the selected image comparison algorithm and obtaining a comparison result. For example, when the sampling comparison algorithm 53 is selected, the calculation module 230 compares with the predetermined length of continuous pixels of two adjacent images. The output control module 250 is configured for directing the display unit 40 to display the comparison result.

As shown in FIG. 2, the control unit 20 further includes a determination module 240. The storage unit 50 is further configured for storing a preset value 55 of each algorithm. When one algorithm is employed, the determination module 240 is configured for determining whether the similarity value reaches the preset value 55 of the selected algorithm. When the similarity value reaches the preset value of the algorithm, the output control module 250 directs the display unit 40 to display the comparison result (that the two images are the same). When the similarity value does not reach the preset value of the algorithm, the output control module 250 directs the display unit 40 to display the comparison result (that the two images are different).

For example, when the algorithm acquisition module 220 acquires the full image comparison algorithm 51, and the calculation module 230 compares each pixel of the two-dimensional arrays of two adjacent images of the multimedia file to obtain the similarity value, such as 96%, the determination module 240 determines whether the similarity value reaches a preset value of the full image comparison algorithm 51, such as 95%. The output control module 250 directs the display unit 40 to display the adjacent images of comparison result. Accordingly, the electronic device 1 may select one algorithm to compare two adjacent images according to needs.

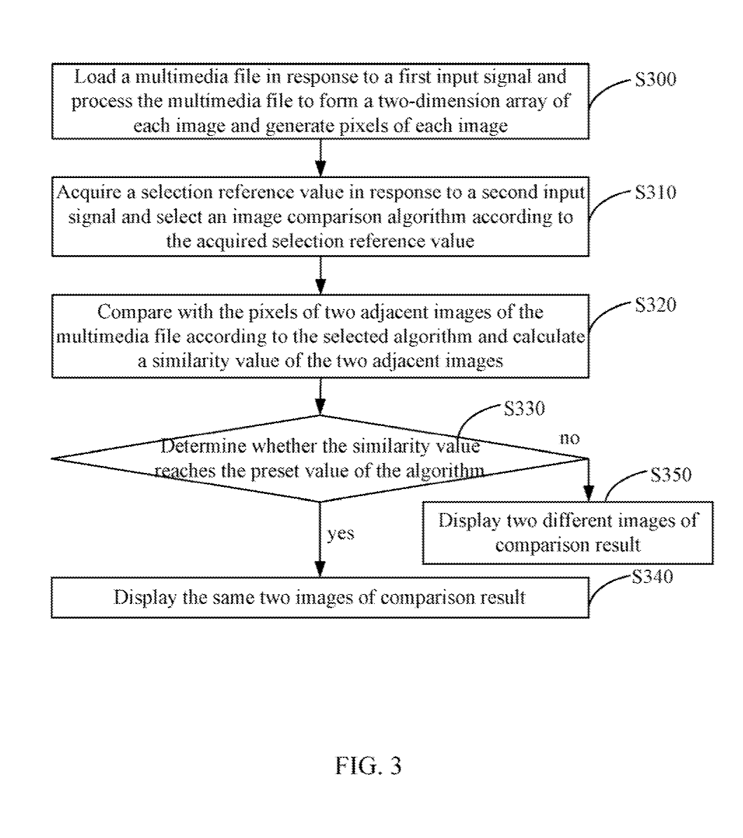

FIG. 3 is a flowchart of an image comparison method utilized in an electronic device such as, for example, that of FIG. 1. In step S300, the file loading module 210 loads the multimedia file in response to the first input signal from the input unit 10 and the image processing unit 30 processes the multimedia file to form a two-dimensional array of each image and generate pixels of each image.

In step S310, the algorithm acquisition module 220 acquires the selection reference value from the storage unit 50 in response to a second input signal from the input unit 10 and selects the image comparison algorithm from the storage unit 50 according to the acquired selection reference value.

In step S320, the calculation module 230 compares with the pixels of the two adjacent images of the multimedia file according to the selected image comparison algorithm from the algorithm acquisition module 220 and calculates the similarity value of the two adjacent images, for example, if the full image comparison algorithm 51 is employed, the calculation module 230 compares with each pixel of the two adjacent images; if the block comparison algorithm 52 is employed, the calculation module 230 compares with each pixel of each block divided by the two adjacent images; and if the sampling comparison algorithm 53 is employed, the calculation module 230 compares with each pixel of the predetermined length of continuous pixels of the two adjacent images.

In step S330, the determination module 250 determines whether the similarity value reaches the preset value of the algorithm. If the similarity value reaches the preset value of the algorithm, in step S340, the output control module 250 directs the display unit 40 to display the same two images of the comparison result. If the similarity value does not reach the preset value of the algorithm, in step S350, the output control module 250 directs the display unit 40 to display two different images of the comparison result.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
an input unit for generating input signals in response to user inputs;
a display unit for displaying information;
a storage unit for storing a plurality of image comparison algorithms and a plurality of selection reference values each of which corresponds to one of the image comparison algorithms;
an image processing unit for processing images to form a two-dimensional array of each image and generate pixels of each image; and
a control unit for loading a multimedia file in response to a first input signal from the input unit, controlling the image processing unit to process the multimedia file to generate pixels of each image of the multimedia file, acquiring a selection reference value in response to a second input signal from the input unit and selecting an image comparison algorithm from the storage unit according to the selected reference value, and comparing with the pixels of two adjacent images according to the selected image comparison algorithm and obtaining a comparison result to be displayed on the display unit.

2. The electronic device as recited in claim 1, wherein the number of the image comparison algorithms is three.

3. The electronic device as recited in claim 2, wherein the image comparison algorithms comprise a full image comparison algorithm, a block comparison algorithm, and a sampling comparison algorithm, the full image comparison algorithm is configured for comparing each pixel of the two-dimensional array of one image with that of an adjacent image and obtaining a similarity value; the block comparison algorithm is configured for dividing each image into a predetermined number of blocks, comparing each pixel of each block of one image with that of an adjacent image, and obtaining a similarity value; the sampling comparison algorithm is configured for sampling a predetermined length of continuous pixels of one image at random, comparing each pixel of the predetermined length of continuous pixels of the image with that of an adjacent image, and obtaining a similarity value.

4. The electronic device as recited in claim 3, wherein the storage unit is further configured for storing a preset value of each algorithm, and the control unit is further configured for when one algorithm is employed, determining whether the similarity value of the selected algorithm reaches the preset value of the algorithm, when the similarity value reaches the preset value of the algorithm, directing the display unit to display the same two images of comparison result, when the similarity value does not reach the preset value of the algorithm, directing the display unit to display two different images of comparison result.

5. An image comparison method utilized in an electronic device, wherein the electronic device stores a plurality of image comparison algorithms and a plurality of selection reference values each of which corresponds to one of the image comparison algorithms, the method comprising:
loading a multimedia file in response to a first input signal and processing the multimedia file to form a two-dimensional array of each image and generate pixels of each image;
acquiring a selection reference value in response to a second input signal and selecting an image comparison algorithm according to the acquired selection reference value; and
comparing with the pixels of two adjacent images according to the selected image comparison algorithm and obtaining a comparison result.

6. The image comparison method as recited in claim 5, wherein the number of the image comparison algorithms is three.

7. The image comparison method as recited in claim 6, wherein the image comparison algorithms comprise a full image comparison algorithm, a block comparison algorithm, and a sampling comparison algorithm, the full image comparison algorithm is configured for comparing each pixel of the two-dimensional array of one image with that of an adjacent image and obtaining a similarity value; the block comparison algorithm is configured for dividing each image into a predetermined number of blocks, comparing each pixel of each block of one image with that of an adjacent image, and obtaining a similarity value; the sampling comparison algorithm is configured for sampling a predetermined length of continuous pixels of one image at random, comparing each pixel of the predetermined length of continuous pixels of the image with that of an adjacent image, and obtaining a similarity value.

8. The image comparison method as recited in claim 7, wherein the electronic device further stores a preset value of each algorithm, the method further comprising:
calculating a similarity value of the two adjacent images of the multimedia file;
determining whether the similarity value reaches the preset value of the algorithm;
if the similarity value reaches the preset value of the algorithm, displaying the same two images of comparison result; and
if the similarity value does not reach the preset value of the algorithm, displaying two different images of comparison result.
